(19) United States
(12) Patent Application Publication
(10) Pub. No.: US 2002/0060839 A1
(43) Pub. Date: May 23, 2002

(54) Hybrid fiber amplifier using dispersion compensating raman amplifier

(76) Inventors: Wang-Yuhl Oh, Taejon (KR); Joon-Hak Bang, Taejon (KR); Sang-Soo Lee, Taejon (KR); Hyun-Jae Lee, Taejon (KR); Je-Soo Ko, Taejon (KR); Wan-Seok Seo, Taejon (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/871,875

(22) Filed: Jun. 4, 2001

(30) Foreign Application Priority Data
Nov. 21, 2000 (KR) 2000-69263

(51) Int. Cl. H01S 3/00

(52) U.S. Cl. 359/337.5

(57) ABSTRACT

The invention relates to a hybrid fiber amplifier in which a dispersion compensating Raman amplifier is associated with an erbium doped fiber amplifier to enhance the amplifier efficiency. It is an object of the invention to provide a dispersion compensating Raman amplifier(DCRA) by inducing Raman pump light into a dispersion compensating fiber to obtain a Raman gain in which a depolarizer is used to eliminate the pump light polarization dependent Raman gain, and a hybrid fiber amplifier in which the DCRA is associated with an erbium doped fiber amplifier(EDFA) to enhance the efficiency. The hybrid fiber amplifier using a dispersion compensating amplifier comprises dispersion compensating Raman amplifier unit for performing a dispersion compensating amplification to an incident optical signal by launching Raman pump light, which is depolarized by a depolarizer, backwardly; and fiber amplifier unit for receiving and amplifying again the optical signal amplified via the dispersion compensating Raman amplifier unit.

### FIELD OF THE INVENTION

The invention relates to a hybrid fiber amplifier (hereinafter referred to as HFA) in which a dispersion compensating Raman amplifier (hereinafter referred to as DCRA) is associated with an erbium doped fiber amplifier (hereinafter referred to as EDFA) to enhance the amplifier efficiency. I particular, a DCRA, which compensating both the transmission link dispersion and the dispersion compensating fiber (hereinafter referred to as DCF) insertion loss, is used as a part of a HFA by inducing the Raman gain in the DCF. A depolarizer is used to eliminate the pump light polarization dependent Raman gain in a DCRA by reducing the degree of polarization of the pump light.

### DESCRIPTION OF THE PRIOR ART

Researches on optical fiber amplifiers (hereinafter referred to as OFA's) as key elements for wide-band WDM transmission applications have been widely conducted, especially on EDFA's, and the commercialized OFA products have been already shown in the market.

Generally speaking, when an electric signal is converted into a light signal at the transmission stage and sent to an intended place via fiber optics, that is, a transmission medium, the EDFA amplifies the light signal weakened by a predetermined distance so as to transmit it as a stable signal. The EDFA is installed at the transmission/reception stage for the purpose of power amplification and pre-amplification. In an earlier single pumping amplifier, the input connector connects an external fiber optic cable to a internal fiber optic cable of the EDFA. A separation tap for separating a light signal input via the fiber optic cable connected by the input connector at a predetermined ratio splits the input light signal, and inputs the split signals to a photodiode and an optical isolator. Here, the photodiode monitors the magnitude of the light signal input. The optical isolator has one input terminal and one output terminal so that it passes the light signal proceeding to the output terminal from the input terminal within a predetermined wavelength, and interrupts the light signal returning back from the output terminal to the input terminal.

Recently, as the data communication traffic increases drastically, demand for a broad band fiber amplifier is rapidly growing. Also, studies about the introduction of the Raman amplification are getting more active since a wavelength band wider than the amplification band of the EDFA is required.

FIG. 1 shows a two-stage EDFA used in the 160 Gb/s WDM transmission system.

In the WDM transmission system using single mode fibers (hereinafter referred to as SMF's) as transmission lines, the accumulated dispersion in the transmission line must be compensated by the DCF module, which is known as one of the most effective methods for dispersion compensation. Therefore, most EDFA's used in such systems, about which was disclosed in “Accurate control of output power level in gain-flattened EDFA with low noise figure” presented in ECOC 97 in 1997 by S. Y. Park, et al., have the two-stage configuration with a DCF module and other loss components such as a gain flattening filter located between each gain block, because of the high insertion loss of the DCF module. However, the configuration of such two-stage EDFA is complicated comparing to the proposed HFA.

The studies about the fiber Raman amplifiers can be mainly classified into two groups of a distributed Raman amplifier in which an optical transmission line itself is used as a gain medium, and a discrete Raman amplifier in which a separate Raman amplifying optical fiber is used to construct as a separate amplifier.

In addition to the above two amplifiers, a HFA can be constructed by associating the FRA and the EDFA.

As a related art, it is disclosed that transmission loss can be compensated by introducing a Raman pumping to the dispersion compensating fiber in “Raman Amplification for Loss Compensation in Dispersion Compensating Fiber Modules” published in “Electron. Lett.” in 1998 by P. B. Hansen, et al, and U.S. Pat. No. 5,887,093 entitled “Optical Fiber Dispersion Compensation” issued in 1999.

In this work, the lossless dispersion compensation was reported by inducing the Raman gain inside the DCF using 225 mW of 1453 nm pump light. Error free transmission through the 71 km of DCF was shown with a 1557.4 nm signal. However, studies about associating the dispersion compensating fiber module, in which the DCF loss is compensated by inducing the Raman gain, with the EDFA are not disclosed in the foregoing documents. Also, studies for obtaining actually suitable value in the optical transmission system by analyzing the intensity and wavelength of the pump light and the length of the DCF have not been carried out.

In other words, the above document discloses only the idea that loss of the DCF can be compensated by introducing the Raman pump in it.

Next, a lossless dispersion compensating fiber module in about 50 nm range is constructed by using total 8 pumping laser diodes from 1435 to 1480 nm as disclosed in “Broad Band Lossless DCF Using Raman Amplification Pumped by Multichannel WDM Laser Diodes” published in “Electron. Lett.” in late 1998 by Y. Emori, et al.

Lossless dispersion compensation over 50 nm wavelength range from 1535 nm to 1585 nm was presented. The total power of 8 pump LD's was 1 W, and the noise figure using 75 km DCF was 9˜10 dB. However, this study discloses only an idea that loss can be compensated if a dispersion compensation module is arranged as one module separate from an amplifier and a Raman pumping is carried out as by P. B. Hansen.

Furthermore, the hybrid fiber amplifier associating the Raman amplifier and the EDFA is disclosed in “Wide-Band and Gain-Flattened Hybrid Fiber Amplifier Consisting of an EDFA and a Multiwavelength Pumped Raman Amplifier” published in “IEEE Photon. Technol. Lett.” in 1999 by H. Masuda, et al.

In this document, total three stage hybrid fiber amplifier is constructed by arranging the EDFA in the front leading end and connecting two stage Raman amplifier consisted of 8.0 and 8.3 km Raman optical fiber in the rear side of the EDFA. Total 9 pump laser diodes, and a gain flattening filter is used to obtain the flattening gain within 1dB in the range of 70 nm, but the transmission experiment data such as BER was not supported.

However, dispersion compensation functions are not disclosed and there are problems that optical signal parameters such as input signal intensity are not the levels used which are used in actual optical communication systems.

Also, there are problems that the pumping structure can have an unstable gain due to the polarization dependent gain within the Raman optical fiber, and when the EDFA gain is high in the leading end, the optical fiber can undergo a nonlinear effect so that the EDFA gain may not be large.

### SUMMARY OF THE INVENTION

The invention is proposed to solve the foregoing problems and it is therefore an object of the invention to provide a hybrid fiber amplifier in which a DCRA is associated with an EDFA so that efficiency can be enhanced.

Also, it is another object of the invention to provide a dispersion compensating Raman amplifier in which a depolarizer is adapted to depolarize the pump light for the Raman gain thereby ensuring a stable amplification signal.

To obtain one object of the invention, it is provided a hybrid fiber amplifier using a dispersion compensating amplifier comprising: dispersion compensating Raman amplifier means for performing a dispersion compensating amplification to an incident optical signal by inducing Raman pump, which is depolarized by a depolarizer, backwardly; and fiber amplifier means for receiving and amplifying again the optical signal amplified via the dispersion compensating Raman amplifier means.

The hybrid fiber amplifier further comprises population inversion enhancement means for increasing population inversion at the leading end of the dispersion compensating Raman amplifier means.

To obtain another object of the invention, it is provided a hybrid fiber amplifier using a dispersion compensating amplifier comprising: depolarizer means for depolarizing incident pump light for a Raman gain; coupler means for inputting the Raman pump light from the depolarizer means into an optical line in backward direction; and dispersion compensating fiber amplifier means for compensating dispersion of the incident optical signal, and coupling the Raman pumped light inputted in backward direction from the coupler means with the incident optical signal to amplify the incident optical signal.

### BRIEF DESCRIPTION OF THE DRAWINGS

The foregoing objects, features and advantages of the invention will be more apparent from the following detailed description in reference to the appended drawings, wherein:

FIG. 1 shows a structure of a conventional two-stage EDFA;

FIGS. 2A and 2B show the structures of hybrid fiber amplifiers according to embodiments of the invention;

FIG. 3 shows the structure of a DCRA 310 using a depolarizer according to an embodiment of the invention;

FIGS. 4A and 4B show measured results of gains and noise figures of the hybrid fiber amplifiers according to the embodiments of the invention;

FIG. 5 is a view for showing an experimental schematic for measuring the BER of the hybrid fiber amplifier of the invention; and

FIGS. 6A and 6B show results of the BER measurement in a channel obtained by the 160 km optical transmission experiment by using 160 Gb/s WDM optical signal to the fiber amplifier of the invention.

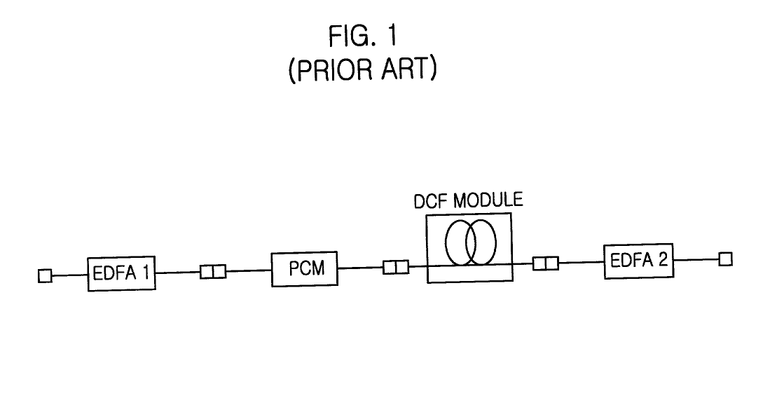

### DETAILED DESCRIPTION OF THE PREFERRED EMBODIMENT

Hereinafter, preferred embodiments of the invention will be described in detail in reference to the appended drawings.

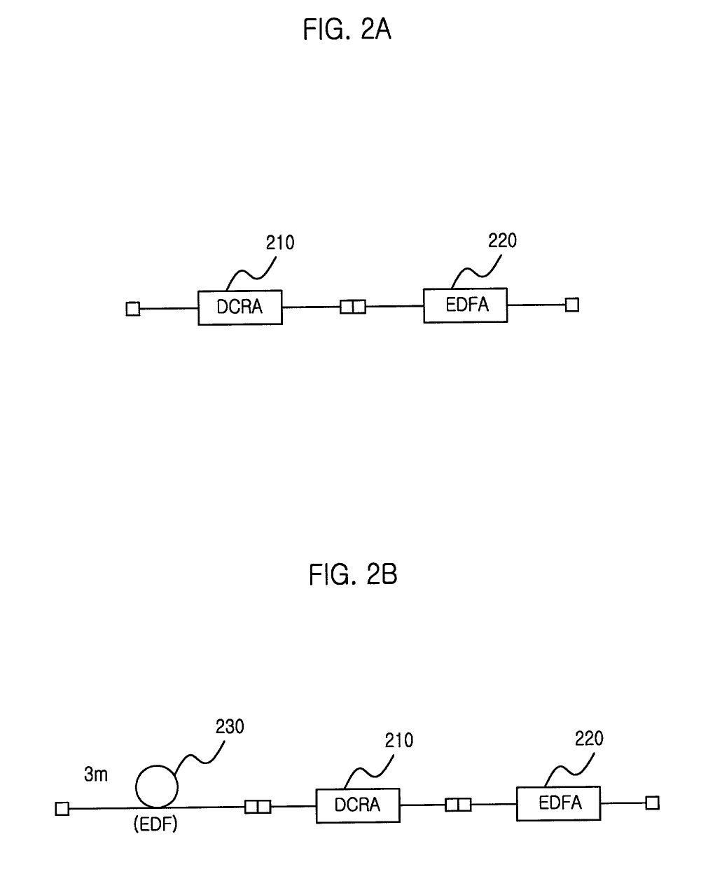

FIGS. 2A to 2B show the structures of hybrid fiber amplifiers according to embodiments of the invention.

FIG. 2A is a hybrid fiber amplifier of the invention, which is a simple structure comprised of a DCRA 210 and an EDFA 220 only.

As shown in FIG. 2A, the hybrid fiber amplifier of the invention has the DCRA 210 for performing a dispersion compensating amplification by using Raman pump light which is depolarized by a depolarizer, and the EDFA 220 for amplifying again the light signal from the DCRA 210.

Here, the EDFA 220 associated with the DCRA 210 in use is structured to pump in forward direction by a laser diode of 980 mm wavelength.

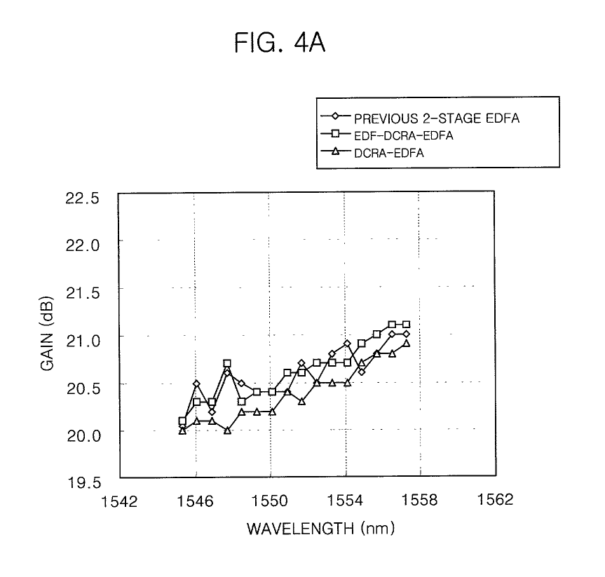

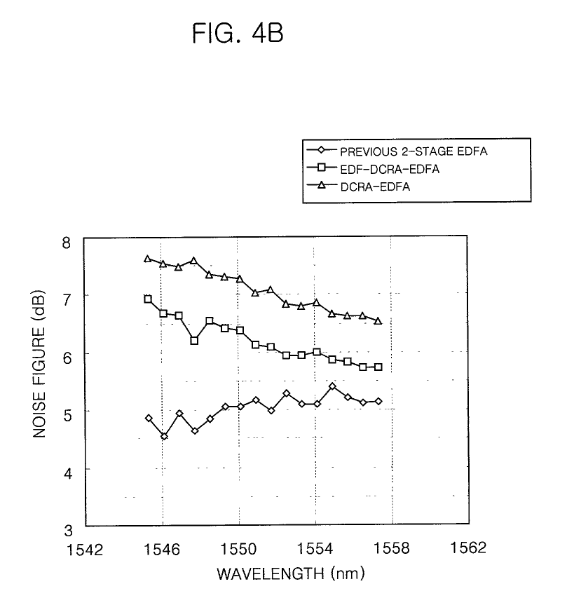

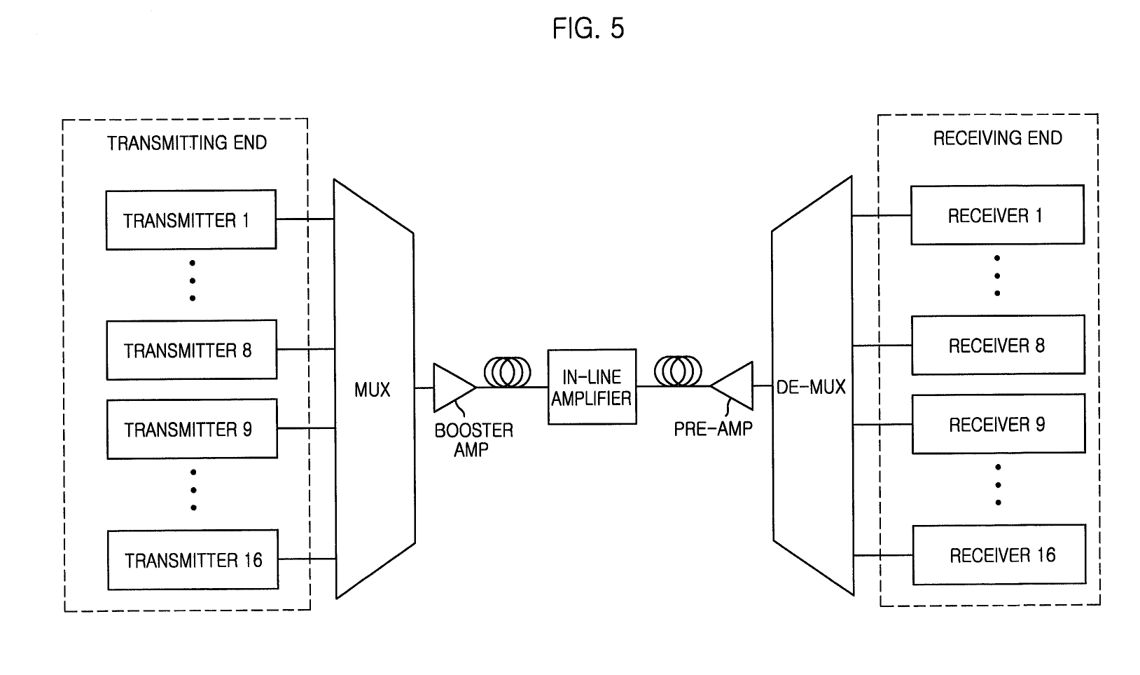

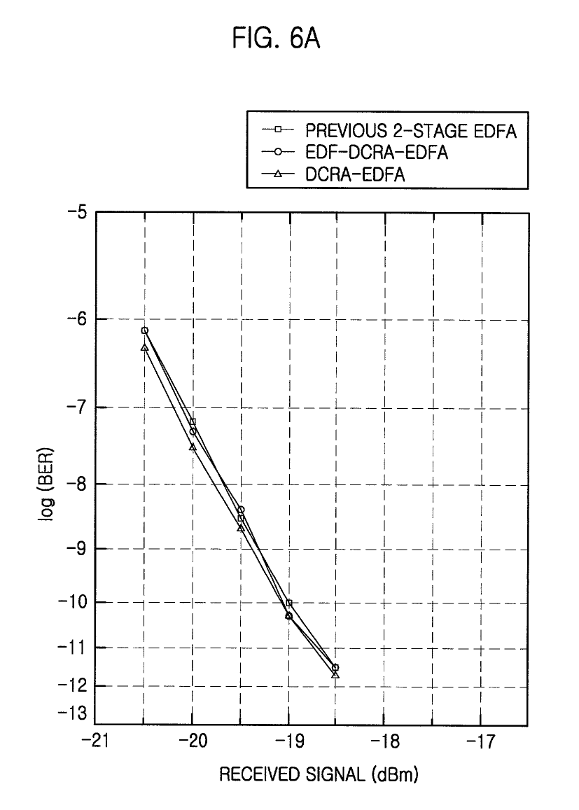

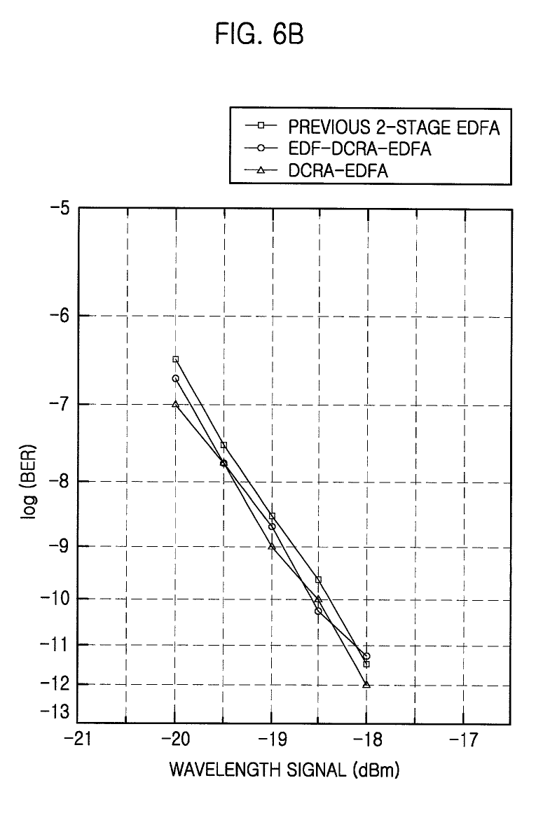

The DCRA 210 is arranged in front of the EDFA module 220 to construct the hybrid fiber amplifier for measuring the gain and noise figure (refer to FIG. 4), and used as an in-line amplifier to perform a 160 km transmission experiment also (refer to FIG. 5 and FIG. 6).

In the foregoing experiment, 16 channels having 0.8 nm spacing, which are used for a 160 Gb/s optical transmission system, are used as signal optical sources, the intensity of the inputted optical signal is −4.5 dBm(−16.5 dBm/ch) in the middle of −7 to −2 dBm which is the range of the in-line amplifier inputting optical intensity in the 160 Gb/s optical transmission system.

In FIG. 2B, a short length erbium doped fiber (hereinafter referred to as EDF) 230 of about 3 m is connected to the leading end of the amplifier to enhance the noise figure.

In other words, as shown in FIG. 2B, the hybrid fiber amplifier of the invention has the EDF 230 for obtaining a high population inversion at the leading end of the optical amplifier, a DCRA 210 for obtaining a dispersion compensating amplification to a signal from the EDF 230 by using Raman pump light which is depolarized by a depolarizer, and an EDFA 220 for amplifying again the optical signal from the DCRA 210.

As can be seen in FIG. 4 and FIG. 6, the amplifier in FIG. 2B shows a gain similar to that of the amplifier in FIG. 2A, and has the noise figure improved about 0.7 to 1.0 dB, and it can be seen that the BER is almost same as in FIG. 2A.

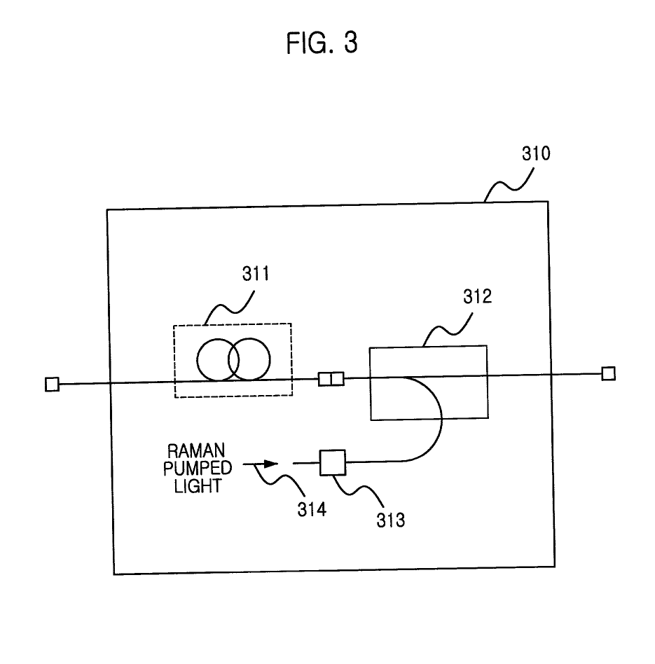

FIG. 3 shows the structure of a DCRA 310 using a depolarizer according to an embodiment of the invention.

As shown in FIG. 3, the DCRA 310 using the depolarizer of the invention has the depolarizer 313 for eliminating polarization dependence of incident pump light for a Raman gain, a coupler 312 for inputting the Raman pumped optical signal in backward direction from the depolarizer 313, and a dispersion compensating fiber module or DCFM 311 for amplifying the inputted optical signal.

The DCRA 310 is comprised of the DCFM 311 actually used in a WDM optical transmission system, and one 1480 nm laser diode used as a Raman pumping light source.

In the invention, to obtain a gain about a signal in 1550 nm regime, the temperature of the pumping laser diode is adjusted so that the center wavelength is adjusted toward the short wavelength of 1465 to 1470 nm.

Also, to eliminate the pump light polarization dependence of the Raman gain, a Lyot type fiber depolarizer 313 is used in the invention, and the pump light is incident in backward direction to eliminate the gain fluctuation according to the pump light intensity fluctuation.

Meanwhile, for the incident optical signal, dispersion compensation is carried out in the DCFM 311, where the pump light 314 for the Raman gain which is incident backwardly via the coupler 312 is coupled for amplification.

However, such a Raman amplifier of the related art has an unstable gain due to the polarization dependence of the incident Raman pump light 314. Therefore, for the stable gain of the amplifier, the Raman pump light 314 is conducted to pass through the depolarizer before passing through the coupler 312 in the invention so that stable amplified signal can be obtained.

FIG. 4A and FIG. 4B show measured results of the gains and the noise figures of the hybrid fiber amplifiers according to the embodiments of the invention.

As shown in FIG. 4A and FIG. 4B, in comparing the gains and noise figures of the amplifiers in FIGS. 2A and 2B of the invention with those of a two stage amplifier of the related art which is actually used in the 160 Gb/s optical transmission system, the gains of the invention have almost the same amount and flatness as those of the related art, and the noise figures of the invention are about 7 dB, which are larger about 1.5 to 2 dB than that of the related art but within the range desired in the transmission system.

FIG. 5 is a view for showing an experimental schematic for measuring the BER of the hybrid fiber amplifier of the invention.

In the 160 km transmission experiment as shown in FIG. 5, each of amplifiers used at the position of an in-line amplifier for the BER measurement for the 16 signal channels.

Measured results of the BER by the above experiment are shown in FIGS. 6A and 6B.

FIGS. 6A and 6B show the results of the BER measurement in a channel obtained by the 160 km optical transmission experiment by using 160 Gb/s WDM optical signal to the fiber amplifier of the invention.

In the transmission experiment, graphs shown in FIGS. 6A and 6B are measured BER values of the corresponding amplifiers for any two channels of the 16 channels used in the experiment, in which the hybrid fiber amplifier in FIGS. 2A or 2B of the invention show the BER that is almost the same or slightly enhanced compared with the two stage EDFA of the related art.

In other words, in comparing with previous two stage EDFA, the hybrid fiber amplifiers of the invention have the simpler structure in which the EDFA in the leading end is omitted while the performance thereof is almost the same as that of the two stage EDFA.

While the invention has been described in reference to the preferred embodiments and the appended drawings, it is apparent to those skilled in the art that various modifications, changes and equivalents can be made within the scope of the invention.

What is claimed is:

1. A hybrid fiber amplifier using a dispersion compensating amplifier comprising:
dispersion compensating Raman amplifier means for performing a dispersion compensating amplification to an incident optical signal by irradiating Raman pumped light which is depolarized by a depolarizer in the reverse direction; and
fiber amplifier means for receiving and amplifying again the optical signal amplified via said dispersion compensating Raman amplifier means.

2. The hybrid fiber amplifier using a dispersion compensating amplifier as recited in claim 1, further comprising population inversion enhancement means for increasing population inversion at the leading end of the said dispersion compensating Raman amplifier means.

3. The hybrid fiber amplifier using a dispersion compensating amplifier as recited in claim 2, wherein said population inversion enhancement means is an EDR(Erbium Doped Fiber) for using the pumped light residing after pumping said Raman amplifier means as exciting light to induce a gain, whereby the population inversion of the leading end of said dispersion compensating Raman amplifier means is increased to enhance the noise figure.

4. A hybrid fiber amplifier using a dispersion compensating amplifier, comprising:
fiber amplifier means for amplifying an incident optical signal; and
dispersion compensating Raman amplifier means for receiving an optical signal amplified via said fiber amplifier means and performing the dispersion compensating amplification to the optical signal by irradiating Raman pumped light which is depolarized by a depolarizer in the reverse direction.

5. The hybrid fiber amplifier using a dispersion compensating amplifier as recited in claim 4, wherein said diversion compensating Raman amplifier means has:
depolarizer means for depolarizing incident pumped light for a Raman gain;
coupler means for inputting the Raman pumped light from said depolarizer means into an optical line in the reverse direction; and
dispersion compensating fiber amplifier means for compensating dispersion of the incident optical signal, and coupling the Raman pumped light inputted in the reverse direction from said coupler means with the incident optical signal to amplify the incident optical signal.

6. The hybrid fiber amplifier using a dispersion compensating amplifier as recited in claim 5, wherein said depolarizer means is a Lyot type fiber depolarizer.

7. The hybrid fiber amplifier using a dispersion compensating amplifier as recited in claim 4, wherein said fiber amplifier means is an EDFA(Erbium Doped Fiber Amplifier).

8. A dispersion compensating amplifier using a depolarizer comprising:
depolarizer means for depolarizing incident pumped light for a Raman gain;
coupler means for inputting the Raman pumped light from said depolarizer means to an optical line in the reverse direction; and
dispersion compensating fiber amplifier means for compensating dispersion of the incident optical signal, and coupling the Raman pumped light inputted in the reverse direction from said coupler means with the incident optical signal to amplify the incident optical signal.

9. The dispersion compensating amplifier using a depolarizer as recited in claim 8, wherein said depolarizer means is a Lyot type fiber depolarizer.
